(19) United States
(12) Patent Application Publication
(10) Pub. No.: US 2026/0064727 A1
(43) Pub. Date: Mar. 5, 2026

(54) Universal Hierarchical Grid-Based Geocoding System and Method

(71) Applicant: John David Hardy, London (GB)

(72) Inventor: John David Hardy, London (GB)

(21) Appl. No.: 18/823,699

(22) Filed: Sep. 4, 2024

(51) Int. Cl. G06F 16/29; G06F 16/22; G06F 16/26

(52) U.S. Cl. CPC G06F 16/29; G06F 16/2246; G06F 16/26

(57) ABSTRACT

A computer-implemented method for encoding geographic locations using a hierarchical grid system. The method involves dividing the Earth's surface into multiple grid levels, with each level further subdivided into grid cells. Each grid cell is assigned a unique identifier derived from an encoding scheme that utilizes a set of unique symbols. The unique identifier for each grid cell is generated based on the consistent positional layout of symbols within the grid. The method includes storing alias data for certain grid cells in a database, receiving input specifying a geographic location, determining the corresponding grid cell within the hierarchical grid, and generating an encoded representation of the location by mathematically deriving the associated unique identifier. This encoded representation is then outputted by the computing device, providing an intuitive and systematic method for geolocation that emphasizes user familiarity with the grid's structure.

### FIELD OF INVENTION

The present invention relates to geocoding systems and methods, specifically to a computer-implemented system for encoding geographic locations using a universal hierarchical grid structure.

### BACKGROUND

In the modern era, with the exponential growth of digital mapping technologies and geolocation services, the demand for precise and user-friendly geocoding systems has intensified. Traditional geocoding methods, which often rely on alphanumeric strings or word-based codes, have become increasingly inadequate in meeting the diverse needs of global users. These conventional systems, while functional, are often limited by their dependence on literacy, language, and detailed knowledge of geographic contexts. This restricts their accessibility and usability, particularly in regions with high population densities, varying literacy levels, and complex geographic landscapes.

Existing geocoding solutions tend to prioritize technical accuracy over user experience, often resulting in codes that are difficult to interpret or remember. The lack of intuitive spatial context in these systems poses significant challenges for users attempting to understand geographic relationships without the aid of a visual map. For instance, while an alphanumeric code might precisely identify a location, it provides little to no information about the location's proximity to other points of interest or its position within a broader geographic area. This disconnect between code and context hinders the practical utility of such systems, especially for users who require a more intuitive understanding of spatial relationships.

Moreover, the rigidity of current geocoding methods often leads to inefficiencies in densely populated or frequently visited areas. The fixed-length codes used by many systems can be cumbersome and unnecessarily complex when a shorter, more flexible code could suffice. In these environments, the need for aliasing or simplified codes becomes apparent, yet many existing solutions fail to offer this adaptability. Additionally, the reliance on purely alphanumeric characters limits the ability to convey nuanced spatial relationships or to provide users with a visual representation that could enhance their understanding of a location's context.

Another significant limitation of traditional geocoding systems is their inability to effectively leverage symbolic or visual representations that could make geolocation more accessible to a broader audience. While symbols and emojis have emerged as a universal language that transcends cultural and linguistic barriers, their potential in the field of geocoding remains largely untapped. Current systems do not fully exploit the cognitive advantages offered by visual symbols, which could simplify the process of location sharing and enhance the user's ability to mentally map geographic spaces.

In light of these challenges, there is a clear need for a geocoding system that not only provides precise location data but also enhances the user's ability to intuitively understand and share geographic information. Such a system should not only utilize a hierarchical grid structure but also maintain a consistent grid arrangement across all levels of spatial resolution. Familiarity with this universal grid structure would enable users to intuitively understand geospatial relationships, providing context through the consistent positioning of symbols within the grid.

This approach would address the shortcomings of existing systems by offering a more flexible, user-friendly approach to geocoding, tailored to meet the diverse needs of a global user base. The development of a system that integrates these features could revolutionize the way geographic locations are encoded, shared, and understood, paving the way for more inclusive and effective geolocation technologies.

It is within this context that the present invention is provided.

### SUMMARY

The present invention provides a computer-implemented method and system for encoding geographic locations using a hierarchical grid system. The method divides the Earth's surface into multiple grid levels, each subdivided into a plurality of grid cells. Each grid cell is associated with a unique identifier derived from an encoding scheme, which comprises a set of unique symbols. These symbols are organized consistently within the grid, enabling a consistent and intuitive layout across all grid levels. The system is configured to store these unique identifiers in a database accessible by a computing device. Upon receiving an input specifying a geographic location, the computing device determines the corresponding grid cell and generates an encoded representation of the geographic location by mathematically deriving the unique identifier associated with that grid cell. This encoded representation is then outputted by the computing device.

In some embodiments, the encoding scheme further includes a base-30 character pair encoding, where each unique symbol corresponds to a pair of characters selected from a predefined set of 30 characters. This allows for a structured and efficient method of generating unique identifiers for grid cells.

In further embodiments, the predefined set of 30 characters comprises the characters 0123456789ABCDEFGHJKMNPQRTVWXY. The omission of visually similar characters such as I, L, O, S, U, and Z reduces potential confusion during encoding and decoding processes.

In yet further embodiments, the base-30 character pairs are arranged within a 30×30 grid, with each pair of characters corresponding to a unique position within the grid. This arrangement facilitates the clear and consistent assignment of unique identifiers to specific grid cells.

In some embodiments, the hierarchical grid system is configured such that the highest grid level encompasses the entire Earth's surface, with each subsequent lower grid level representing a finer subdivision. The highest grid level may use a 10×20 subset of the grid, leaving certain positions unassigned at that level, which can be used for densely populated cells at lower levels. This configuration allows for the scalable encoding of geographic locations at varying levels of detail. Subsequent grid levels would then be organized into 30×30 cell arrangements in such embodiments.

In further embodiments, the hierarchical grid system comprises at least five grid levels, with each subsequent grid level increasing the precision of the geographic location representation. This multi-level approach enables the method to adapt to different use cases, requiring various degrees of locational precision.

In yet further embodiments, the lowest grid level provides a geographic location resolution of approximately 2.5 meters when using a 20×10 subset of the grid at the highest level, or a higher resolution when the full 30×30 grid is used. This flexibility allows the system to adjust the resolution based on specific use cases or geographic considerations.

In some embodiments, the unique identifier associated with some grid cells includes an alias, which serves as a shortened or alternative representation for grid cells in densely populated or frequently accessed areas. This feature enhances the ease of location sharing in these regions.

The method may also include the clustering of symbols within the grid system based on their positional layout. Each cluster represents a thematic category, such as modes of transport, animals, or landmarks. This clustering provides a clearer visual organization of symbols, aiding in the user's interpretation of geographic data through consistent and intuitive layouts.

In yet further embodiments, the computing device is configured to display the hierarchical grid system and associated symbols to a user, allowing for interactive engagement with the grid system to specify or retrieve geographic locations. This interactive feature enhances the usability of the system by leveraging familiar symbol positions within the grid.

In some embodiments, the computing device includes a user interface that allows users to input geographic locations by interacting with the displayed grid system. This interface streamlines the process of location entry and retrieval, ensuring users can efficiently engage with the system.

In further embodiments, the method includes dynamically adjusting the hierarchical grid system to accommodate changes in geographic features or population density. The adjustments involve updating the alias data associated with affected grid cells while maintaining the consistent grid structure, ensuring that the system remains accurate and relevant over time.

In further embodiments, the encoding scheme is a base-900 encoding scheme.

In such embodiments, the symbols in the base-900 encoding scheme include emojis, pictograms, or other visual representations that can be displayed on a digital interface. These symbols enhance the visual appeal and interpretability of the encoded locations.

In yet further embodiments, the encoded representation of the geographic location includes additional metadata, such as elevation information, associated with the specified location. The metadata is represented by additional characters appended to the unique identifier, providing a more comprehensive locational context.

In yet further embodiments, the characters are selected from a predefined set of alphabetic or numeric characters and are positioned within the unique identifier based on a predefined schema. This systematic approach ensures consistency in the encoding of additional locational information.

In some embodiments, the database storing the unique identifiers for each grid cell supports alias-based searches, allowing users to input an alias to retrieve the corresponding geographic location. This feature simplifies the retrieval process for frequently accessed or well-known locations.

In further embodiments, alias-based searches prioritize aliases corresponding to densely populated or frequently accessed areas, displaying results to the user in order of relevance. This prioritization improves the efficiency of location retrieval in high-traffic regions.

In yet further embodiments, the computing device is configured to encode and decode geographic locations in real-time, enabling dynamic location sharing and retrieval in applications such as navigation, weather reporting, social networking, or location-based gaming. This capability ensures that users can quickly and accurately share and retrieve location information as needed.

In some embodiments, the encoded representation of the geographic location is transmitted to a remote server, which is configured to decode the representation to determine the corresponding geographic location. This server-based decoding facilitates the integration of the system with other digital services and platforms.

In further embodiments, the remote server includes a mapping interface that visually displays the decoded geographic location to the user based on the received encoded representation. This mapping feature allows users to view and interact with the decoded location on a digital map.

### BRIEF DESCRIPTION OF THE DRAWINGS

Various embodiments of the invention are disclosed in the following detailed description and accompanying drawings.

FIG. 1 illustrates an example computer-implemented method for encoding and retrieving geographic locations using a hierarchical grid system represented by emojis.

FIG. 2A illustrates an example top-level world grid in the hierarchical grid system, showing large geographic regions represented by emojis.

FIG. 2B illustrates an example mid-level regional grid focusing on Europe, showing more specific areas within the continent represented by emojis.

FIG. 2C illustrates an example third-level grid for the city of Rome, showing detailed subdivisions of the regional cell containing the city, represented by a sequence of emojis.

FIG. 2D illustrates an example third-level grid for the city of Berlin, showing detailed subdivisions of the city represented by a sequence of emojis.

FIG. 3A illustrates an example thematic grid for transport modes, organized by speed and type of vehicle.

FIG. 3B illustrates an example thematic grid for winged animals, organized by size and type of bird or insect.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### Detailed Description and Preferred Embodiment

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “hierarchical grid system” refers to a structured division of the Earth's surface into multiple levels of grid cells, where each level provides a different degree of spatial resolution. This system may include, but is not limited to, a series of nested grids, each finer grid being a subdivision of a broader grid cell from a higher level. In one example implementation, the hierarchical grid system divides the Earth's surface into an initial global grid, which is then recursively subdivided into smaller grids, each representing increasingly precise geographic locations. The grid structure remains consistent across all levels, and user familiarity with the grid's layout provides intuitive geospatial context.

The term “base-900 encoding scheme” refers to a method of representing geographic locations using a set of 900 unique symbols. These symbols may include, but are not limited to, alphanumeric characters, emojis, pictograms, or other graphical representations. Each symbol in the base-900 set is used to encode geographic data based on its position within a universal grid structure. In one example implementation, the base-900 encoding scheme may utilize a base-30 character pair system, where each pair of characters corresponds to a unique symbol within the 900-symbol set, facilitating the encoding of geographic data into a compact, yet informative, format.

The term “unique identifier” refers to a code or sequence of symbols that uniquely represents a specific grid cell within the hierarchical grid system. This identifier is generated based on the encoding scheme and the position of the symbol within the grid. In one example implementation, the unique identifier may consist of a base-30 character pair combined with an associated symbol from the encoding scheme, creating a distinct code that can be stored, transmitted, and decoded by computing devices.

The term “computing device” refers to any electronic device capable of processing data, executing software, and performing the steps required to encode and decode geographic locations as described in the invention. This may include, but is not limited to, personal computers, servers, smartphones, tablets, and specialized location-based hardware. In one example implementation, the computing device may be a mobile application running on a smartphone, which receives user input, processes the input to determine the corresponding grid cell, and outputs the encoded geographic location to the user.

The term “database” refers to any structured collection of data stored electronically, which is used to store the unique identifiers associated with grid cells in the hierarchical grid system. The database may be implemented using relational databases, NoSQL databases, or other data storage technologies. In one example implementation, the database may be hosted on a remote server accessible via the internet, allowing computing devices to query the database to retrieve or store geographic identifiers in real-time.

The term “symbol” refers to any visual or graphical representation used in the encoding scheme to denote a specific grid cell within the hierarchical grid system. Symbols may include alphanumeric characters, emojis, pictograms, or other graphical icons. Symbols are organized based on their positional layout within a universal grid.

The term “alias” refers to an alternative or shortened representation of a unique identifier, particularly for grid cells located in densely populated or frequently accessed areas. The alias is designed to simplify the encoding and sharing of geographic locations by reducing the number of characters or symbols required to represent a specific location. In one example implementation, the alias may be generated by assigning unused symbols or positions from higher grid levels to represent popular locations, allowing for more efficient data transmission and easier user interaction.

### Description of Drawings

The present invention relates to a computer-implemented method and system for encoding geographic locations, which addresses significant limitations in existing geocoding technologies. Traditional geocoding methods, which often rely on alphanumeric strings or word-based codes, frequently fail to provide users with an intuitive understanding of geographic relationships. These existing systems typically require users to rely on external tools, such as maps or databases, to interpret location codes, and they do not effectively convey the spatial proximity or contextual relevance of different locations. Furthermore, conventional geocoding methods often lack flexibility in representing densely populated areas or frequently visited locations, leading to unnecessarily complex or lengthy codes.

The invention overcomes these shortcomings by introducing a hierarchical grid system that divides the Earth's surface into multiple levels of grid cells, each providing a different degree of spatial resolution. This system is coupled with an encoding scheme that utilizes a set of unique symbols to represent geographic locations within the grid. Unlike prior approaches, the symbols in this system are organized based on their consistent positional layout within the grid. This consistency allows users to build an intuitive understanding of spatial relationships through familiarity with the grid's layout, without the need for additional tools or complex interpretation.

One of the significant advantages of this invention is its ability to generate unique identifiers for geographic locations that are both compact and systematically derived. In some examples, these identifiers are generated based on the position of the symbol within the grid, in combination with a base-30 character pair and a symbol from a base-900 set. The use of symbols, which may include emojis, pictograms, or other graphical representations, enhances the accessibility of the system, enabling users from diverse linguistic and cultural backgrounds to interpret and share geographic information with ease.

Additionally, the invention introduces the concept of aliases for certain grid cells, particularly those located in densely populated or frequently accessed areas. These aliases provide a simplified and more efficient way to represent these locations, reducing the number of characters or symbols required and streamlining the process of location sharing. The aliasing system leverages unassigned positions within the grid, allowing for a flexible and scalable approach to geocoding.

The hierarchical grid system is also designed to be flexible in terms of resolution. While a typical resolution of approximately 2.5 meters is sufficient for most location-sharing purposes, the system allows for additional symbols to be appended to increase the resolution as needed, similar to adding decimal places in numerical systems. The flexibility in grid usage, such as employing a 10×20 subset at the highest grid level, ensures that the system can accommodate different geographic and population density requirements while maintaining a consistent grid layout.

This approach to geocoding not only simplifies the process of encoding and decoding geographic locations but also provides a user-friendly interface that can be adapted for various applications, from digital mapping and navigation to educational tools and gaming. The consistent and intuitive layout of symbols within the grid ensures that users can easily navigate and understand the geospatial context of any location within the grid, making this system a significant improvement over traditional geocoding methods.

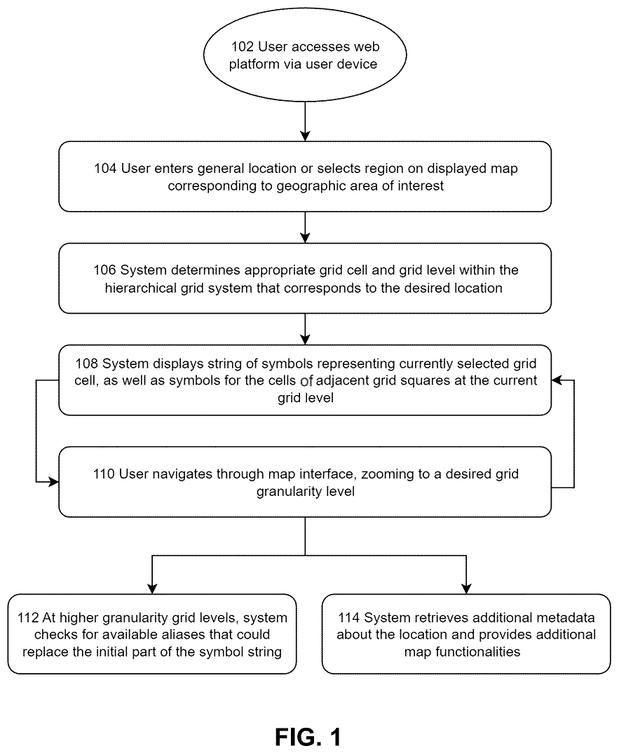

Referring now to the drawings, FIG. 1 illustrates an example implementation of the computer-implemented method for encoding and retrieving geographic locations using a hierarchical grid system, where the spatial grids are represented using a sequence of emojis. The user interacts with the system through their user device to find location information for a business within a highly populated city, such as Rome.

The method begins with the user accessing the platform through a user device, such as a smartphone or tablet, which connects to the system's computing infrastructure (102). The user interface displayed on the device allows the user to interact with the hierarchical grid system. The user initiates the process by either entering a general location or selecting a region on a displayed map corresponding to the broader geographic area of interest, such as the city of Rome (104).

The computing device then determines the appropriate grid cell within the hierarchical grid system that corresponds to the general location of the city (106). The hierarchical grid system divides the Earth's surface into multiple levels, with each level offering a finer degree of spatial resolution. Thus once the selected location is determined, a string of symbols, i.e. emojis, is continuously displayed to represent the respective grid cell and level that the user has navigated to. The symbols of the other cells of the grid level that the user has navigated to. The symbols representing adjacent grid cells at the same grid level are also displayed overlaid on the map interface (108). In this example, the system uses emojis to represent these grid cells. A combination of emojis is thus used to denote the general location of Rome, such as a flamingo (1A), and two bear symbols (B2-B2). The surrounding grid will show the other emojis representing areas adjacent to Rome.

As the user navigates between cells and grid levels, the system dynamically updates the map interface and overlay to continue to represent the selected cell and adjacent grid cells (108). Navigating to higher granularity grid levels generates an increasingly longer string of emojis, where each additional emoji corresponds to a more detailed level within the grid structure, for example further narrowing down the area to a specific part of Rome. For example, selecting an area within Rome could involve an additional emoji being appended to the existing sequence, like a fish emoji, creating a more specific code such as “1A-B2-B2-Fish.”

As the user continues to zoom in or specify the location more precisely, the grid cells at lower levels are selected, and further emojis are appended to the string. Ultimately, when the user specifies a precise location, such as a specific building or street, the system identifies the corresponding grid cell within the lowest level of the hierarchy. While a typical resolution might correspond to a 2.5-meter square area, the system allows for higher precision by appending additional symbols as needed. The final emoji string might look something like [1A-B2-B2-BB-33] if character pairs were used, or [flamingo-bear-bear-fish-scooter] if emojis were used.

If the location is in a densely populated or well-known area, the system checks for available aliases that could replace the initial part of the emoji string, shortening it for easier use (112). For example, instead of displaying the full sequence “1A-B2-B2,” the system might offer an alias such as “A1” to represent a specific cell containing Rome (120), depending on the unassigned positions available within the grid. The final output could then be something like “A1-Fish-Scooter,” simplifying the representation while maintaining the same level of precision.

The user interface may also offer options to retrieve additional metadata about the location, such as business details, contact information, or directions based on the final emoji sequence (114). This step completes the location retrieval process, allowing the user to easily share or navigate to the precise location within the city.

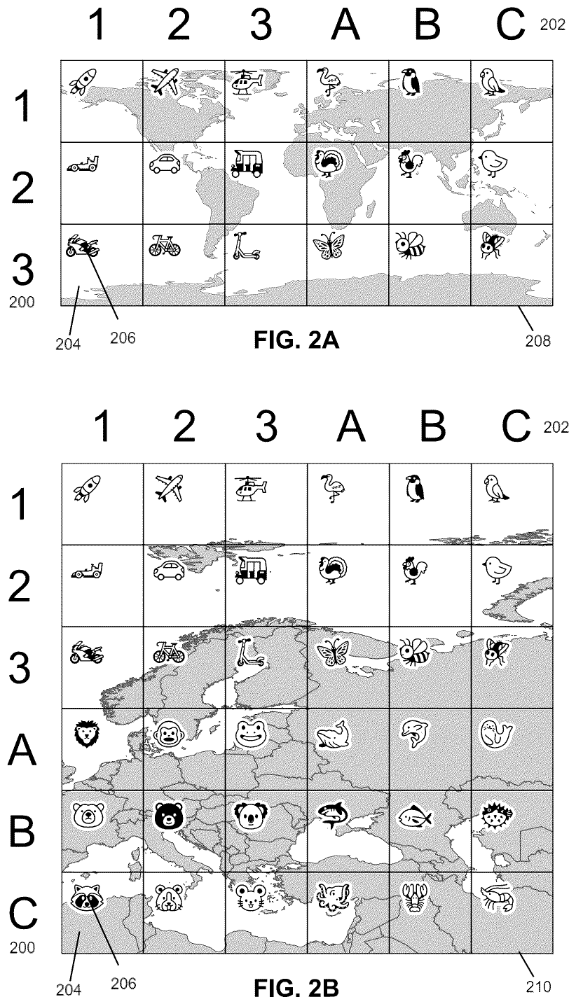

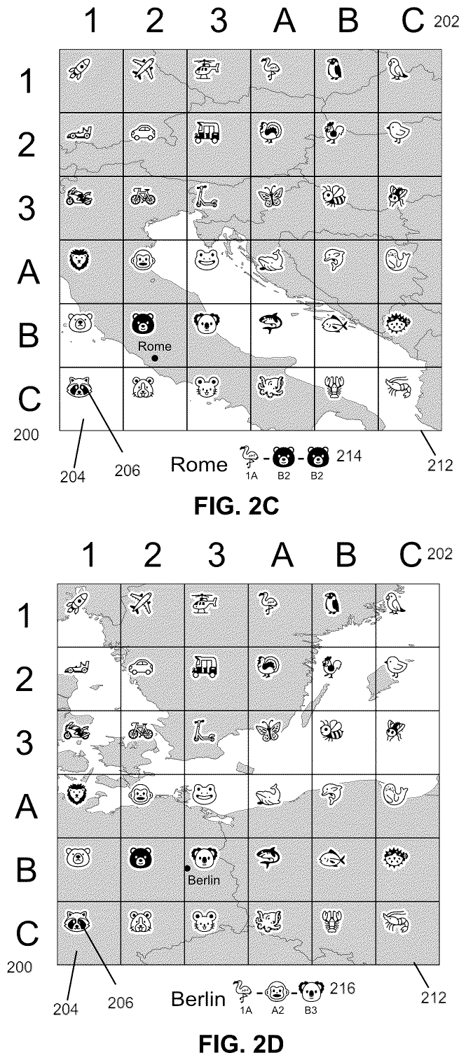

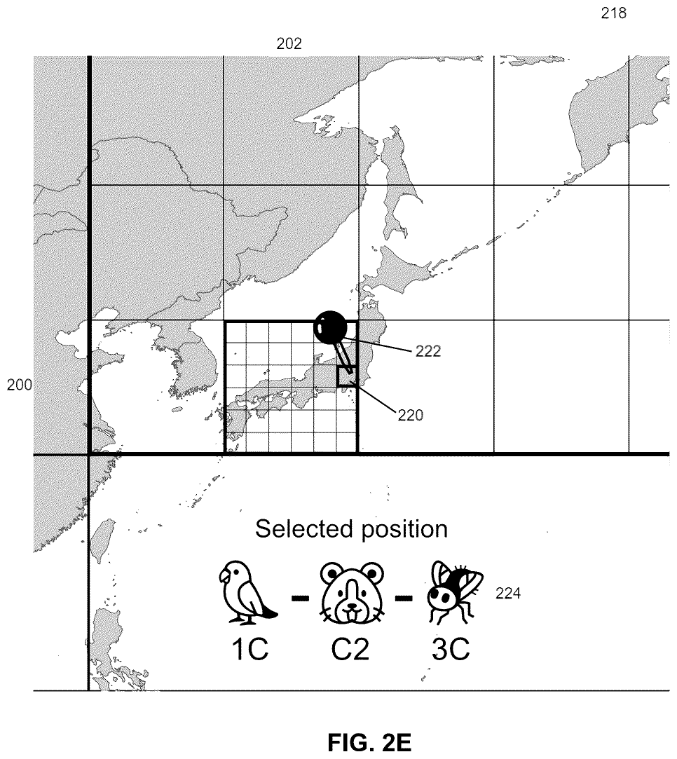

FIGS. 2A, 2B, 2C, and 2D illustrate the hierarchical grid system used in the invention, depicted across multiple levels of granularity with the representation of geographic locations using emoji symbols.

FIG. 2A illustrates the top-level world grid (Level 1) displayed on a user interface. The grid is organized into rows (200) labeled 1, 2, 3, and columns labeled 1, 2, 3, A, B, C (202), representing large geographic regions of the Earth's surface. The grid is divided into two primary clusters: the left 3×3 grid contains emojis representing different types of transport vehicles, and the right 3×3 grid contains emojis representing various flying animals.

Each grid cell (204) within these clusters is associated with a unique emoji symbol (206). These symbols are arranged within the grid based on a consistent positional layout. The arrangement of symbols is designed to facilitate user familiarity with the grid's structure. For example, transport vehicle emojis are consistently grouped in one section, while winged animals are grouped in another, allowing users to develop an intuitive understanding of where certain types of symbols are likely to be found on the grid.

This clustering of symbols within the grid structure (208) is intended to help users build a mental model of the grid's organization. The symbols do not reflect specific geographic properties of the regions they represent; rather, their consistent positioning aids in navigation and location identification. The grid at this level serves as the broadest overview of the world's geography, providing a starting point for users to navigate to more detailed grid levels.

FIG. 2B illustrates the mid-level regional grid (Level 2) focused on the European region, where the grid is divided into six rows (200) labeled 1, 2, 3, A, B, C, and six columns (202) labeled 1, 2, 3, A, B, C, creating a 6×6 matrix. This grid (210) is organized into clusters of symbols that provide visual cues to help users intuitively understand the layout and navigate the grid.

The top-left section of the grid, which includes rows 1, 2, 3 and columns 1, 2, 3, contains symbols representing various types of transport vehicles. Within this section, grid cells (204) are associated with emojis (206) such as a “Rocket,” “Car,” and “Bicycle,” denoting different types of transportation. These symbols are consistently placed to help users build familiarity with the grid layout, making it easier to navigate and understand the positioning of different areas related to transportation.

The top-right section, covering rows 1, 2, 3 and columns A, B, C, features symbols related to winged animals. This section includes grid cells (204) containing emojis (206) like a “Flamingo,” “Penguin,” and “Bird,” which represent various flying animals. These symbols are organized in a way that allows users to intuitively understand the layout and the relative position of locations within this part of the grid.

The bottom-left section, formed by rows A, B, C and columns 1, 2, 3, includes symbols representing animal faces. In this section, grid cells (204) include emojis such as a “Lion,” “Bear,” and “Monkey,” each symbolizing different types of terrestrial fauna. This consistent placement aids users in associating these symbols with specific locations within the grid, helping them navigate the region effectively.

The bottom-right section, occupying rows A, B, C and columns A, B, C, includes symbols related to sea-based animals. Here, grid cells (204) are represented by emojis (206) such as a “Fish,” “Lobster,” and “Dolphin,” symbolizing regions associated with maritime features or coastal areas. This clustering does not reflect the actual geographic attributes of the regions but rather provides a consistent and intuitive way to understand the layout of the grid.

In this mid-level grid, the arrangement of symbols into these clusters is designed to help users build a mental model of the grid's structure. The thematic clustering of symbols supports the user's ability to intuitively navigate the grid and identify the relative position within Europe. For instance, a location represented by a sea-based animal would be located in the southeastern quadrant of the European grid, while a location marked by a winged animal would be in the northeastern quadrant.

The organization of this Level 2 grid (210) into these thematic clusters ensures that users can quickly and easily discern the general area and type of location they are viewing, aiding in navigation and the refinement of searches to more specific locations within Europe. This system supports the overarching goal of the invention by making geographic information both accessible and visually intuitive through the use of consistently placed and recognizable symbols.

FIG. 2C illustrates the third-level grid (Level 3) focused on the city of Rome. This grid (212) represents a more granular division of the geographic area, focusing specifically on the grid of cells showing the region around Rome, with the specific cell that contains Rome being easily identifiable. The structure of the grid remains consistent with the layout seen in FIG. 2B, with six rows (200) labeled 1, 2, 3, A, B, C, and six columns (202) labeled 1, 2, 3, A, B, C. The four thematic clusters—transport vehicles, winged animals, animal faces, and sea-based animals—are applied here as well, just on a smaller, more detailed scale.

The sequence of emojis (214) representing the cell containing Rome at this level includes symbols such as “Flamingo-Bear-Bear” (1A-B2-B2), which were established in the previous grid levels. As users navigate within this third-level grid, the consistent positioning of symbols continues to provide intuitive spatial understanding. The specific areas of Rome correspond to specific clusters of symbols, helping users orient themselves within the grid.

FIG. 2D depicts another example of a third-level grid, this time focusing on the region containing the city of Berlin. The grid (212) shares the same structure and layout as the Rome grid, with six rows (200) labeled 1, 2, 3, A, B, C, and six columns (202) labeled 1, 2, 3, A, B, C. The grid is organized into general clusters of symbols, including transport vehicles, winged animals, animals faces, and sea-based animals.

The sequence of emojis for Berlin (216) might include symbols such as “Flamingo-Monkey-Bear” (1A-A2-B3). As above, the clusters serve to give users an intuitive understanding of the city's layout based on the established grid structure.

FIG. 2E illustrates an example of a user interface (218) for interacting with the hierarchical grid system, specifically focusing on a selected position (220) within the region surrounding Tokyo. The interface displays a zoomed-out view of the area with different grid levels visible, showcasing how the hierarchical grid system can be navigated across different levels of granularity. The grid is organized in a manner consistent with the previous figures, dividing the region into rows (200) and columns (202).

As the user hovers the search cursor (222) over a specific location within Tokyo, the interface highlights the corresponding grid cell (220) within the grid structure, dynamically adjusting to display increasingly detailed subdivisions of the area as the user zooms in. The selected position is represented by a sequence of emojis (224) that provides an intuitive understanding of the location within the hierarchical grid system. In this case, the emojis “Parrot-Bear-Bee” (1C-C2-3C) are displayed, corresponding to the specific grid cells that represent Tokyo at this level of granularity.

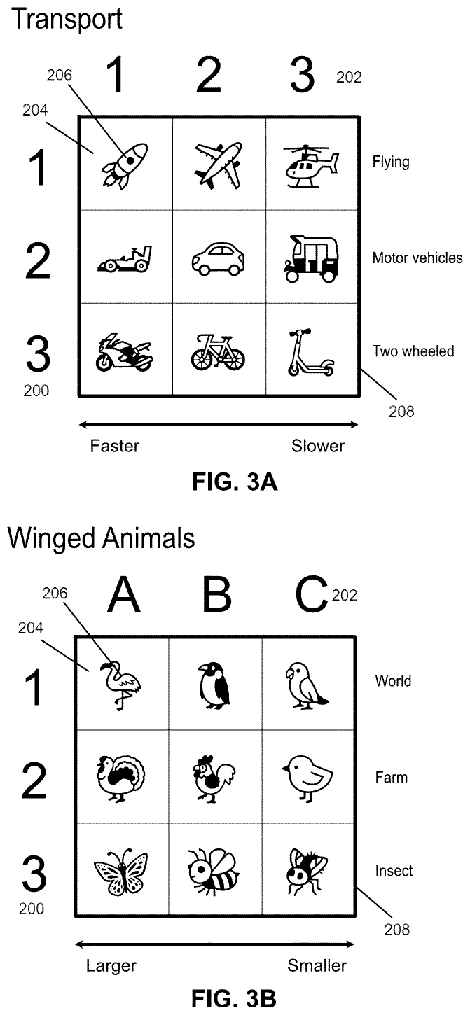

FIGS. 3A and 3B illustrate how the hierarchical grid system overlay organizes and categorizes symbols within thematic groups, exemplified by grids representing transport modes and winged animals. These figures demonstrate the application of clustering within the grid system, which aids in user familiarity and intuitive navigation.

FIG. 3A depicts a 3×3 grid labeled “Transport,” where each grid cell (204) is associated with an emoji (206) representing a different mode of transportation. The grid is organized along two axes: speed (from faster to slower, left to right) and type of transport (from flying vehicles in the top row to two-wheeled vehicles in the bottom row). The rows (200) and columns (202) are labeled to reflect this categorization, with the grid cells arranged to help users intuitively understand the positioning of transportation-related symbols within the grid. For instance, cell 1,1 features a “Rocket” emoji representing the fastest flying vehicle, while cell 3,3 features a “Scooter” emoji representing the slowest two-wheeled vehicle.

This arrangement allows the system to organize symbols in a way that supports user familiarity with the grid layout. The clustering of related symbols within the grid system (208) ensures that the layout is intuitive, helping users quickly recognize the general category of symbols and infer their position within the grid.

FIG. 3B presents an alternative 3×3 grid cluster, labeled “Winged Animals,” where each grid cell (204) contains an emoji (206) representing a different bird or insect. The grid is organized along two axes: size (from larger to smaller, left to right) and type of winged animal (from world birds in the top row to insects in the bottom row). The rows (200) and columns (202) in this grid are labeled to reflect this categorization. For example, cell A1 contains a “Flamingo” emoji, representing a large bird, while cell C3 features a “Fly” emoji, representing a small insect.

### Controller/Processor Components

The operations described herein may be carried out by a server or any other suitable controller or processor or computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for encoding geographic locations, the method comprising:
dividing the Earth's surface into a hierarchical grid system, wherein the hierarchical grid system comprises multiple grid levels, each grid level being subdivided into a plurality of grid cells, and each grid cell at a higher grid level being further subdivided into smaller grid cells at a lower grid level;
associating each grid cell with a unique identifier, wherein the unique identifier is derived from an encoding scheme comprising a set of unique symbols, and wherein the unique identifier for each grid cell is generated based on the position of the symbol within the grid;
storing data for certain grid cells in a database, the database being accessible by a computing device;
receiving, by the computing device, an input specifying a geographic location to be encoded;
determining, by the computing device, the grid cell corresponding to the specified geographic location within the hierarchical grid system;
generating, by the computing device, an encoded representation of the geographic location by mathematically deriving the unique identifier associated with the determined grid cell; and
outputting, by the computing device, the encoded representation of the geographic location.

2. The method of claim 1, wherein the encoding scheme is a base-900 scheme, and further comprises a base-30 character pair encoding, wherein each unique symbol in the set of symbols corresponds to a pair of characters selected from a predefined set of 30 characters.

3. The method of claim 2, wherein the predefined set of 30 characters comprises the characters 0123456789ABCDEFGHJKMNPQRTVWXY.

4. The method of claim 2, wherein the base-30 character pairs are arranged within a 30×30 grid, and each pair of characters corresponds to a unique position within the 30×30 grid.

5. The method of claim 1, wherein the hierarchical grid system is configured such that the highest grid level encompasses the entire Earth's surface, and each subsequent lower grid level represents a finer subdivision of the Earth's surface.

6. The method of claim 1, wherein the hierarchical grid system comprises at least five grid levels, each subsequent grid level increasing the precision of the geographic location representation.

7. The method of claim 6, wherein the lowest grid level provides a geographic location resolution of approximately 2.5 meters.

8. The method of claim 1, wherein the unique identifier associated with one or more grid cells is further configured to include an alias, the alias being a shortened or alternative representation of the unique identifier for grid cells located in densely populated or frequently accessed areas, alias data being included in the data stored in the database.

9. The method of claim 1, wherein the unique identifier for each grid cell comprises a combination of a base-30 character pair and an associated symbol from the encoding scheme.

10. The method of claim 1, further comprising the step of clustering symbols within the grid system based on their positional layout within the grid, wherein each cluster of symbols represents a thematic category, such as modes of transport, animals, or landmarks, to facilitate user familiarity with the grid structure.

11. The method of claim 1, wherein the computing device is configured to display the hierarchical grid system and the associated symbols to a user, allowing the user to interact with the grid system to specify or retrieve geographic locations.

12. The method of claim 1, wherein the computing device further comprises a user interface configured to allow the user to input geographic locations manually.

13. The method of claim 1, wherein the symbols in the encoding scheme include emojis, pictograms, or other visual representations that can be displayed on a digital interface.

14. The method of claim 13, wherein the symbols are arranged within the grid system such that their visual properties, such as color, shape, or design, correlate with their associated attributes.

15. The method of claim 1, wherein the encoded representation of the geographic location includes additional metadata, such as elevation information, associated with the specified location, and the metadata is represented by one or more additional characters appended to the unique identifier.

16. The method of claim 1, wherein the database storing the unique identifiers for each grid cell is configured to support alias-based searches, allowing users to input an alias to retrieve the associated geographic location.

17. The method of claim 1, wherein the encoded representation of the geographic location is transmitted to a remote server, and the remote server is configured to decode the representation to determine the corresponding geographic location.
